(19) United States
(12) Patent Application Publication
(10) Pub. No.: US 2016/0235110 A1
(43) Pub. Date: Aug. 18, 2016

(54) METHOD AND APPARATUS FOR CONTROLLING THE FLOW OF PRODUCT OVER A PRODUCT ATTRITION BED

(71) Applicant: Frito-Lay North America, Inc., Plano, TX (US)

(72) Inventors: Rick Wendell BAJEMA, Plano, TX (US); Keith Alan BARBER, Frisco, TX (US); Stephen GRAHAM, Plano, TX (US); Peter L. HAYES, Flower Mound, TX (US); Kevin KRETER, Dallas, TX (US); Julian ROMANCZUKIEWICZ, Plano, TX (US)

(21) Appl. No.: 14/624,416

(22) Filed: Feb. 17, 2015

(51) Int. Cl. A23N 7/02

(52) U.S. Cl. CPC A23N 7/02

(57) ABSTRACT

A method and apparatus for controlling a flow of a product over a product attrition bed, where the product comprises a plurality of product units, for example, potatoes. In one aspect, apparatus comprises a product attrition bed and an auger positioned above the product attrition bed. The auger comprises a flow restriction mechanism to restrict a discharge flow of the product from the auger. In a second aspect, the method comprises feeding the product to the auger to provide a product charge; substantially confining the product charge in a charge space; rotating the auger to move the charge space, and thereby the product charge, in the flow direction; and discharging the product charge from the auger through a flow restriction mechanism. In a third aspect, the method and apparatus controls the feed of product to the auger, for example, providing one control volume of product per revolution of the auger.

### BACKGROUND OF THE INVENTION

1. Technical Field

The present invention relates to the use of augers for controlling the flow of a product over a product attrition device, for example, the flow of potatoes over a potato peeler.

2. Background

Food attrition devices typically comprise an open chamber where product freely tumbles from entrance to exit making contact with various forms of abrasive to remove the product's skin. Contact time, movement of product, and bed height are critical in the process. Examples of food attrition devices and various components thereof are illustrated and described in U.S. Pat. No. 4,519,305, U.S. Pat. No. 5,858,429, U.S. Pat. No. 7,197,978, and U.S. Pub. No. 2006/0005715, which are hereby incorporated by reference as illustrative examples.

Because the product can tumble freely in the product attrition device after exiting the auger or before entering the auger, the residence time of any individual unit of product can vary greatly from an average residence time for the product in the food attrition device. As a result, the amount of skin removed from each unit of product can vary, which can be undesirable in terms of reduced efficiency, reduced product capacity, and variable product quality.

Compounding this problem is the fact that existing product attrition devices supply product to a product attrition apparatus at a variable feed rate. For example, even if an existing product attrition device were to use an auger, the feed rate to the auger is variable, which results in fluctuations in volume of product per auger flight.

Previous devices have claimed to use augers to control only a feed rate of product at an entrance of a food attrition device (e.g., U.S. Pub. No. 2006/0005715) or only a discharge rate of a product from the food attrition device (e.g., U.S. Pat. No. 4,519,305). Other devices (e.g., U.S. Pat. No. 5,858,429 and U.S. Pat. No. 7,197,978) have claimed to use an auger to control a feed rate to the food attrition device, but have not provided an auger extending substantially an entire length of a product attrition bed and have not provided a desirable degree of control over the residence time of the product. Nor do these devices provide for feeding a specific volume of product to each pitch length of an auger positioned over a product attrition bed.

For these and other reasons, the utilization of augers as currently practiced in the industry can be improved upon. Accordingly, it would be desirable if a product attrition apparatus provided a controlled residence time without substantially inhibiting product tumbling and could maintain a desired bed height from entrance to exit of the product attrition device with a high degree of predictability and repeatability (e.g., low standard deviation in residence time and/or bed height for each pitch length of an auger).

For example, it would be desirable if an auger extended the entire length of an abrasive so it could control residence time of particles over the abrasive.

It would be desirable if a first auger section had a larger pitch to avoid inhibiting product motion, but a second auger section comprised a flow restriction device to maintain a higher bed height of the product along a greater length of the auger, and thereby maintain a higher bed height along a greater length of an abrasive for removing skin from a product.

For example, it would be desirable if the auger comprised a first auger section with a larger pitch to avoid restricting product tumbling and a second auger section with a smaller pitch for maintaining the bed height of the product over the abrasive.

It would also be desirable if the auger comprised a first auger section with a larger pitch to avoid restricting product tumbling and a second auger section with multiple auger flights for maintaining the bed height of the product over the abrasive.

As another example, it would be desirable if the auger comprised a first auger section with a larger pitch to avoid restricting product tumbling and a second auger section with a rotary gate to maintain the bed height of the product over the abrasive.

Furthermore, it would be desirable if a product attrition apparatus were provided with a controlled volumetric feed rate. For example, it would be desirable to limit variations in the volumetric feed rate to the auger and thereby limit fluctuations in volume of product per auger flight.

### SUMMARY OF THE INVENTION

In one aspect, the present invention provides a product attrition apparatus with improved flow control for a product comprising a plurality of product units. The product attrition apparatus comprises a product attrition bed and an auger positioned above the product attrition bed. The product attrition bed abrades the product while the auger conveys the product in a flow direction. The auger comprises a rotational axis of the auger oriented parallel to the flow direction, an auger flight coiled around the rotational axis, a first auger section, and a second auger section downstream of the first auger section. The auger is configured in relation to the product attrition bed to form a charge space for substantially confining a product charge of the product. As the auger rotates on the rotational axis, the charge space moves in the flow direction, thereby moving the product charge in the flow direction. Additionally, the first auger section comprises a minimum pitch of about 4 times an average equivalent spherical diameter of the product, and the second auger section comprises a flow restriction mechanism to restrict a discharge flow of the product from the auger.

In a second aspect, the present invention provides a method for using an auger to control a flow of a product over a product attrition bed. The product comprises a plurality of product units, and the auger conveys the product above the product attrition bed in a flow direction while the product attrition bed abrades the product. The method comprises the steps: feeding the product to the auger to provide a product charge; substantially confining the product charge in a charge space; rotating the auger to move the charge space, and thereby the product charge, in the flow direction; and discharging the product charge from the auger through a flow restriction mechanism to provide a discharge flow of the product. Furthermore, a first end of the charge space and a second end of the charge space are bounded by the auger; a bottom of the charge space is bounded by the product attrition bed; the first auger section of the auger is upstream of a second auger section of the auger; and the second auger section comprises the flow restriction mechanism to restrict the discharge flow of the product.

In a third aspect, the present invention provides an apparatus for providing one control volume of a product to an auger per revolution of the auger. The auger extends the length of a product attrition bed for abrading the product as it is conveyed by the auger in a charge space. The charge space is bounded by the auger and the product attrition bed.

In a fourth aspect, the present invention provides a method for controlling a volumetric feed rate of product to an auger positioned over a product attrition bed, said method comprising the steps: feeding one control volume of product to an auger per revolution of the auger; rotating the auger to convey the product in a charge space bounded by the auger and the product attrition bed; abrading the product by contact with the product attrition bed; and discharging the control volume from the auger. The auger extends the length of a product attrition bed.

The invention described herein provides for several advantages in its various embodiments. In one aspect, the invention provides a controlled residence time without substantially inhibiting product tumbling and maintains a desired bed height from entrance to exit of the product attrition device with a high degree of predictability and repeatability (e.g., low standard deviation in residence time and/or bed height for each pitch length of an auger).

In another aspect, the invention provides for an auger that extends the entire length of an abrasive to the control residence time of particles over the abrasive.

Additionally, the invention provides for a first auger section comprising a larger pitch to avoid inhibiting product motion, and a second auger section comprising a flow restriction device to maintain a higher bed height of the product along a greater length of the auger. Accordingly, the invention provides for maintaining a higher bed height along a greater length of an abrasive for removing skin from the product.

For example, the invention provides for an auger comprising a first auger section with a larger pitch to avoid restricting product tumbling and a second auger section with a smaller pitch for maintaining the bed height of the product over the abrasive.

As another example, the invention provides for an auger comprising a first auger section with a larger pitch to avoid restricting product tumbling and a second auger section with multiple auger flights for maintaining the bed height of the product over the abrasive.

Additionally, the invention provides for an auger comprising a first auger section with a larger pitch to avoid restricting product tumbling and a second auger section with a rotary gate to maintain the bed height of the product over the abrasive.

In another aspect, the invention provides a product attrition apparatus with a controlled volumetric feed rate. For example, in one aspect, the invention limits variations in the volumetric feed rate to the auger and thereby limits fluctuations in volume of product per auger flight.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic view of one embodiment of a product attrition apparatus with a modified feed chute for controlling the volumetric feed rate of product.

FIG. 2 is schematic view of one embodiment of an auger with a second auger section comprising a plurality of auger flights.

FIG. 3 is a schematic view of one embodiment of an auger with a second auger section comprising a reduced pitch relative to a first auger section.

FIG. 4 is a schematic view of one embodiment of an auger with a second auger section comprising a rotary gate.

FIG. 5A is a plot showing an example of how the total number of product units in a product attrition bed varies with time when the product is conveyed with a single flight, single pitch auger.

FIG. 5 is a schematic view illustrating one embodiment of a product attrition apparatus comprising a single flight, single pitch auger and illustrating how the average residence time of product units in a product charge varies along the length of the auger.

FIG. 6A is a plot showing an example of how the total number of product units in a product attrition bed varies with time when the product is conveyed with an auger comprising a second auger section with a double flight.

FIG. 6 is a schematic view illustrating one embodiment of a product attrition apparatus with an auger comprising a double flight and illustrating how the average residence time of product units in a product charge varies along the length of the auger.

FIG. 7 is a schematic view illustrating one embodiment of a control volume of product.

FIG. 8 is a schematic view illustrating one embodiment of an auger with a truncated drive shaft.

FIG. 9 is a schematic view illustrating a coordinate system superimposed over one embodiment of a product attrition apparatus and illustrating how two auger flights can be out of phase.

FIG. 10A is a flow chart illustrating steps for one embodiment of a method for controlling the flow of product in a product attrition bed.

FIG. 10B is a flow chart illustrating steps for one embodiment of a method for controlling the feed of product to an auger.

### DETAILED DESCRIPTION OF THE INVENTION

In developing the invention disclosed herein, the inventors realized that it is useful to design an auger 104 based on the size of product 502 conveyed. For example, using an auger 104 with a smaller pitch 302 (e.g., less than about 4 times the average equivalent spherical diameter 514) advantageously produces a lower standard deviation in residence time relative to a larger pitch 202 (e.g., greater than about 4 times the average equivalent spherical diameter 514). However, a smaller pitch 302 can be problematic because it restricts product movement due to contact with the auger surface which can prevent exposure of all product surfaces to an abrasive 154.

Accordingly, the inventors worked to develop an auger 104 with a single larger pitch size (e.g., 750 mm pitch) to provide substantially free product mixing and tumbling. The auger 104 was used in a product attrition apparatus with a stationary S shaped exit gate and was positioned about ¼ inch above an abrasive 154. The auger 104 did not extend the full length of an abrasive 154; however, the auger stretched over a substantial portion of the abrasive to help prevent back-mixing, control the residence time of the product over the abrasive, and provide a more uniform degree of product attrition (e.g., peeling). The first end 208 of the auger was a distance (e.g. about a foot) from an entrance to the product attrition bed 102. Likewise, the second end 210 of the auger was a distance from the exit of the product attrition bed.

Using a larger pitch auger helped address the problem of restricted product movement because the larger pitch resulted in less restricted motion. However, because the auger 104 had a single larger pitch, when the last auger pitch opened to discharge product, the bed height 516b dropped over a relatively larger distance from the exit of the auger (e.g., the distance across a terminal portion 536 of the auger).

This can be undesirable because the loss in bed height reduces the normal force between the product and the abrasive 154. The reduction in normal force, in turn, results in a loss of potential peeling capacity for a length of the abrasive 154 (e.g., the length under the lower bed height 516b).

The inventors also realized other problems. For example, since the auger flight 106 did not extend the entire length of the abrasive 154, free mixing (e.g., loss of control over residence time for product) occurred over the abrasive 154 before the first end 402 of the auger flight 106 and after the second end 404 of the auger flight.

In order to address the problem of free mixing, the inventors designed (e.g., using a computer and a discrete elements method to model the product flow) a larger pitch auger 104 with an auger flight 106 that extended the full length of a product attrition bed 102. For example, the auger flight 106 extended an entire length of an abrasive 154 on the surface of product attrition bed. This advantageously provided plug flow of the product 502 within a flight 106 of the auger 104. For example, the product 502 formed a plurality of product charges 512 and each product charge was substantially confined in a charge space 510 formed between two portions of the auger 104 and the abrasive 154. As a result, the auger 104 reduced back-mixing of product from a downstream portion of the product attrition bed 102 to an upstream portion of the product attrition bed. The auger 104 also provided a more controlled residence time of each unit 502 of product in a product charge 512, and a more uniform attrition (e.g., peeling) of product within each product charge. The auger 104 also enabled operators to decrease residence time, or increase the speed at which product 502 travels across the product attrition bed 102.

Nonetheless, the larger pitch, full-length auger still presented several potential problems. For example, stagnation resulted at a pinch point between the second end 404 of the auger flight 106 and the stationary exit gate of the product attrition bed 102. Additionally, some back-mixing occurred at the exit gate of the product attrition bed.

The inventors addressed these issues by removing the stationary exit gate from the product attrition bed 102 (e.g., using the computer model). This removed the pinch point between the stationary exit gate and the auger 104. Removing the stationary exit gate also reduced back-mixing.

However, the inventors realized that removing the gate without providing the auger 104 with a flow restriction mechanism would result in a loss of bed height 516 within the final pitch length before the exit end of the auger. As a result, the peeling capacity of the abrasive 154 would be reduced along the final pitch length of the auger.

In order to mitigate the pinch point problem associated with the stationary gate, while still maintaining bed height at the end of the auger, the inventors decided to add a flow restriction mechanism to the second end 210 of the auger itself (e.g., using the computer model).

One example of a flow restriction mechanism is a rotary gate 406 fixed to the second end 404 of a larger pitch, full length auger flight 106. In one embodiment, the rotary gate 406 is fixed to the second end 404 of the auger flight and located in a plane that is perpendicular to the rotational axis 506 of the auger 104. The rotary gate 406 extends in the same direction as the auger flight 106, and the gate has substantially the same radius 138 as the auger flight.

The rotary gate 406 blocks the discharge flow 155 of product from a blocked area at the exit of the auger. The blocked area is defined by the sweep of the radius of the rotary gate, which sweeps from the second end 404 of the auger flight for a selected angle (e.g., greater than 0 degrees, greater than 0 degrees but a maximum of 270 degrees, or from about 90 to about 180 degrees, inclusive).

Using an auger 104 with a rotary gate 406 results in less stagnation at the second end 210 of the auger and reduces back-mixing. However, the inventors realized that additional improvements were possible.

Accordingly, the inventors developed a larger pitch, full-length auger, with another type of flow restriction mechanism (e.g., using the computer model). Namely, the inventors developed an auger 104 that comprises a first auger section 108 (e.g., upstream auger section) and a second auger section 110 (e.g., downstream auger section) with a smaller pitch 302 than the first auger section 108. As a result of using a smaller pitch 302 in the second auger section 110, the bed height 516c over a first portion 110a (e.g., upstream portion) of the second auger section 110 is increased relative to what it would have been if the second auger section 110 did not have a smaller pitch.

However, the inventors again realized that additional improvements were possible. For example, if the smaller pitch is ½ the larger pitch in the first auger section 108, the linear velocity of the product over the product attrition bed 102 is cut in half. This is because product 502 only travels 1 pitch per revolution (or turn) of the auger 104 so the linear velocity of the product in the auger is the pitch divided by the time required for one revolution of the auger. Thus, the linear velocity of product 502 passing through the second auger section 110 becomes a limiting factor (e.g., bottleneck) for the overall linear velocity of the product conveyed by the auger.

Accordingly, the inventors developed a different type of flow restriction mechanism for the second auger section 110 (e.g., using the computer model). Namely, the inventors developed a second auger section 110 with a plurality of auger flights 206 (e.g., a double flight).

In one embodiment, the second auger flight 204 of the double flight 206 extends for a fraction of a revolution, (e.g., ½ revolution or 180 degrees) from second end 404 of a first auger flight 106. Additionally, the second auger flight 204 has the same shape as the first flight, but is out of phase with the first flight by a phase shift angle 924 (e.g., 180 degrees).

One benefit of using a plurality of flights 206 is that linear velocity of the product in the second auger section 110 is the same as the linear velocity of the product in the first auger section 108. Accordingly, using a plurality of flights 206 does not result in a bottle neck in the second auger section 110.

Nonetheless, the inventors realized that further improvements were possible. For example, the inventors realized that the volumetric feed rate to an auger can vary (e.g., +/−15%). Because the bed height in a charge space 510 of the auger is dependent upon the volume of product fed into the charge space, variations in the volumetric feed rate cause variations in bed height from one charge space to another. This, in turn, causes less predictable results (e.g., the standard deviation of the residence time of a product unit 502 can be greater than desired).

In order to address this issue, the inventors determined that it would be desirable to provide the auger 104 with one fixed volume of variable sized product units 502 per revolution of the auger. Accordingly, the inventors developed (e.g., using the computer model) a method and apparatus for controlling the volumetric feed rate to an auger.

For example, in one embodiment, a container 116, such as a hopper, can be added to a product attrition apparatus and used to intermittently empty product 502 into the product attrition bed 102. This advantageously provides each charge space 510 along the auger 104 with approximately the same volume of product, the same product bed height, and the same pressure between the product and the abrasive 154.

However, the inventors realized that retrofitting a product attrition apparatus to include a feed hopper would be expensive. Accordingly, the inventors developed a less costly method for retrofitting a product attrition apparatus. Namely, the inventors added a primary gate 120 (e.g., slide gate) to a downstream portion of a feed chute 118 for an auger 104 and a secondary gate 124 (e.g., slide gate) to an upstream portion of the feed chute. This creates a volume bounded on its bottom and sides by the feed chute, primary gate, and secondary gate. A sensor 128 (e.g., level sensor) is used to measure the volume of product.

While product 502 is accumulating between the primary gate 120 and the secondary gate 124, the primary gate is closed but the secondary gate is open. Then, when a desired volume 112 of product has accumulated, the secondary gate closes and the primary gate opens to discharge the product to the auger 104.

Advantageously, when using some embodiments of the invention described herein, an operator of a product attrition bed 102 can independently control several important parameters that determine the degree of attrition (e.g., peeling) experienced by a product 502. First, an operator can control the angular velocity 926 (e.g., revolutions per minute) of auger 104, which, in turn, enables an operator to control residence time for each product charge 512. Second, an operator can control the volumetric feed rate 122 to the auger (e.g., volume of product fed to the auger per revolution), which, in turn, controls the bed height of product in each charge of the auger. Third, an operator can control the speed an abrasive 154 (e.g., the speed of roller brushes used to abrade the product).

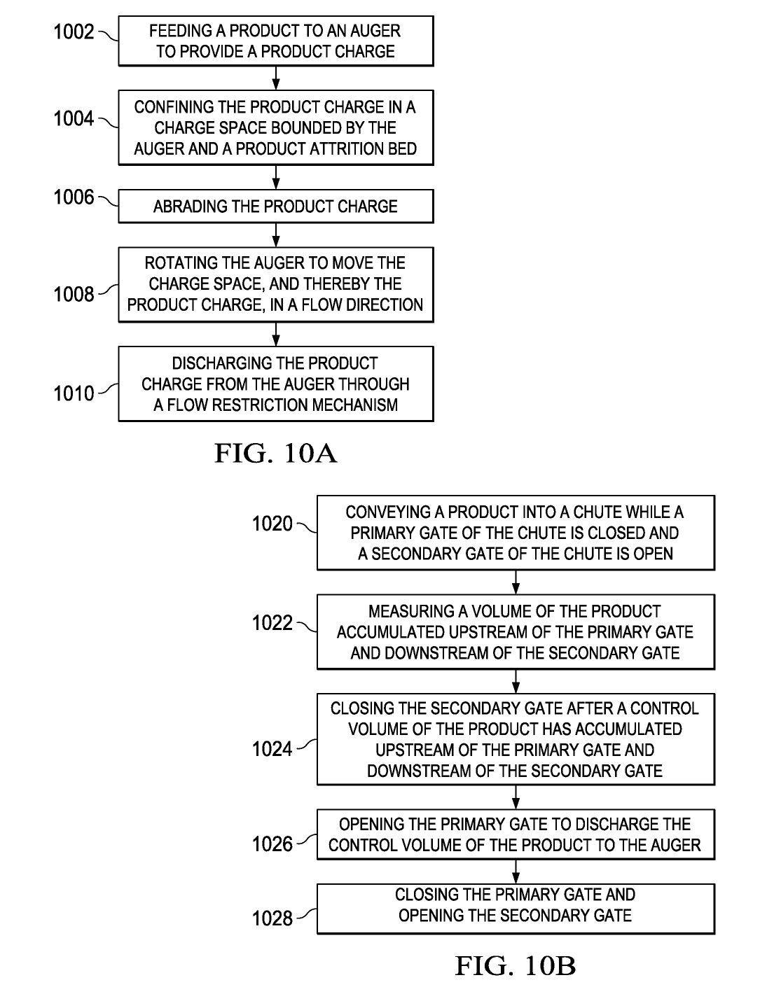

An embodiment of the invention will now be described with reference to FIG. 10A. FIG. 10A is a flow chart depicting a method for using an auger 104 to control a flow of a product 502 in a product attrition bed 102. The auger conveys the product 502 above the product attrition bed 102 in a flow direction 504 while the product attrition bed 102 abrades (e.g. severs and/or removes) the product 502. The method comprises several steps.

First, in a feeding step 1002, product 502 is fed to the auger 104 to provide a product charge 512.

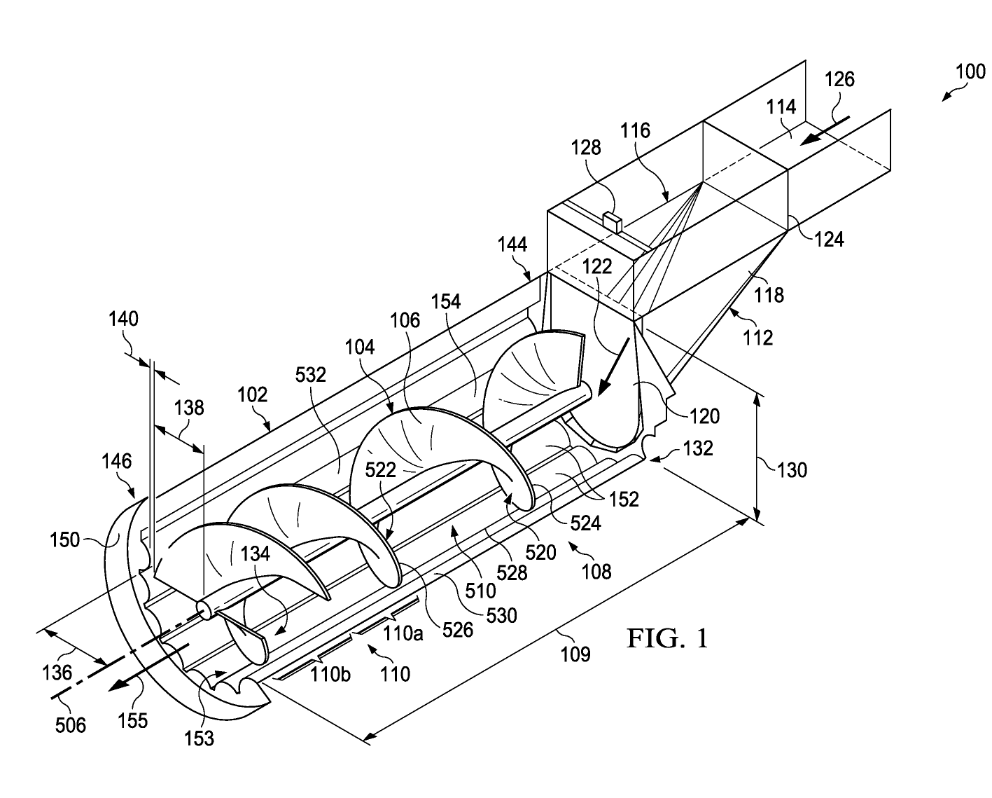

Second, in a confining step 1004, the product 502 is completely or substantially confined in a charge space 510. As illustrated, for example, in FIG. 1, a first end 520 of the charge space 510 and a second end 522 of the charge space 510 are bounded by the auger 104, and a bottom 528 of the charge space 510 is bounded by the product attrition bed 102.

Third, in an abrading step 1006, the product charge 512 is abraded by an abrasive 154 (e.g., bristles or blades).

Fourth, in a rotating step 1008, the auger 104 is rotated to move the charge space 510, and thereby the product charge 512, in the flow direction 504.

Fifth, in a discharging step 1010, the product charge 512 is discharged from the auger 104 through a flow restriction mechanism (e.g., reduced pitch 302, a plurality of auger flights 206, or a rotary gate 406) to provide a discharge flow 155 of the product 502.

In some embodiments, the product 502 comprises a plurality of product units 502a,b (e.g., potatoes, vegetables, etc.), and the product attrition bed 102 abrades at least an outer surface (e.g., skin and/or peeling) of one of the product units 502a,b.

With reference to FIG. 10A, the abrading step 2006 can be performed using a variety of methods and types of product attrition beds 102. For example, the abrading step 2006 can be accomplished by scrubbing, sanding, peeling, cutting or otherwise removing at least a portion of an outer surface of a product 502. In one embodiment, for example, as illustrated in FIG. 1, the product attrition bed 102 comprises a frame 150 on which a plurality of parallel rollers 152 are rotatably mounted in parallel relation to define a longitudinally extending, upwardly opening trough. As another example, the product attrition bed 102 can comprise a frame 150 on which a plurality of blades or some other abrasive 154 is mounted.

Similarly, the feeding step 1002, can be accomplished in a variety of ways. For example, in some embodiments, one control volume 112 of the product 502 is fed to the auger 104 per revolution of the auger to provide a product charge 512. In one embodiment, the control volume 112 varies by a maximum of +/− about 5% to 20% from a specified volume. In one embodiment, the volumetric feed rate of product to the auger has a standard deviation of approximately 20%.

One example of a feeding step 1002, is illustrated in the flow chart of FIG. 10B. First, in a conveying step 1020 as illustrated in FIGS. 1 and 7, a product 502 is conveyed into a chute 118 while a primary gate 120 of the chute 118 (e.g., downstream gate) is closed and while a secondary gate 124 of the chute 118 (e.g., upstream gate) is open. Second, in a measuring step 1022, for example, as shown in FIG. 7, a volume 702 of the product accumulated upstream of the primary gate 120 and downstream of the secondary gate 124 is measured. For example, in one embodiment, the volume 702 of the product is measured by using a level sensor 128 to measure a level 130 of the product and the level is converted to the volume 702 of the product. Third, in a closing step 1024, after a control volume 112 or a fraction (e.g., 1/20, 1/10, ⅕, ¼, ⅓, ½) of a control volume 112 of the product has accumulated upstream of the primary gate 120 and downstream of the secondary gate 124, the secondary gate 124 is closed. For example, this prevents the product 502 from flowing past the secondary gate 124 after the control volume 112 or fraction of a control volume 112 has accumulated. Fourth, in an opening step 1026, the primary gate 120 is opened to discharge the control volume 112 or fraction of a control volume 112 to the auger to provide the product charge 512. Fifth, in a repositioning step 1028, after discharging the control volume 112 or fraction of a control volume 112 to the auger, the primary gate 120 is closed, and then the secondary gate 124 is opened. In some embodiments, the fraction of the control volume provides a specific volume and dividing the control volume by the specific volume results in an integer, for example, so the control volume is evenly divisible by the specific volume. In some embodiments, a container is sized to hold the specific volume. In some embodiments, the container or a plurality of the containers provide a control volume to the auger.

Although the invention has been described with reference to a gate, in some embodiments, a flow control mechanism can be used in place of the gate. For example, the secondary gate can be a secondary control mechanism, which can, in turn be any device or structure to regulate (e.g., completely obstruct) the flow of product downstream of the secondary control mechanism and upstream of the primary gate. Examples of secondary control mechanisms include a sliding gate, or a conveyor (e.g., endless conveyor) for the product that can be started and stopped. Accordingly, as used in this context, a secondary control mechanism is open when it enables or causes product to flow past the secondary control mechanism to a position (e.g., along a chute) that is downstream of the secondary control mechanism and upstream of the primary gate. Similarly, as used in this context, a secondary control mechanism is closed when it prevents or stops causing product to flow past the secondary control mechanism to a position (e.g., along a chute) that is downstream of the secondary control mechanism and upstream of the primary gate.

As desired, the steps of FIG. 10B, or some portion thereof, can be repeated, for example, to provide a single control volume 112 (e.g., product charge 512) to the auger 104 per revolution of the auger. Additionally, the components described with reference to FIG. 10B can be used to retrofit an existing feed chute 118 of a product attrition apparatus 100. For example, after adding a primary gate 120 and a secondary gate 124 to an existing chute 118 to provide a control volume 112 or a fraction of a control volume 112, and after adding a sensor (e.g., level sensor 128) to the chute 118 to measure the control volume 112, the method of FIG. 10B can be used to control the volumetric feed rate of a feed 122 of product to a product attrition apparatus 100 (e.g., to an auger 104 of the product attrition apparatus 100).

As another example of a feeding step 1002, a control volume 112 or a fraction of a control volume 112 of the product 502 can be fed to the auger 104 from a conveyor 114 comprising a plurality of containers 116. For example, in one embodiment, the invention comprises a conveyor 114 for feeding a control volume 112 or a fraction of a control volume 112 of product to the auger 104. The conveyor 114 comprises a plurality of containers 116 (e.g., buckets) and each container 116 is sized to contain (e.g., has a volume equal to) the control volume 112 or a fraction of a control volume 112. The conveyor 114 feeds the auger 104 one control volume 112 of product 502 from one or more containers 116 in the plurality of containers per revolution of the auger.

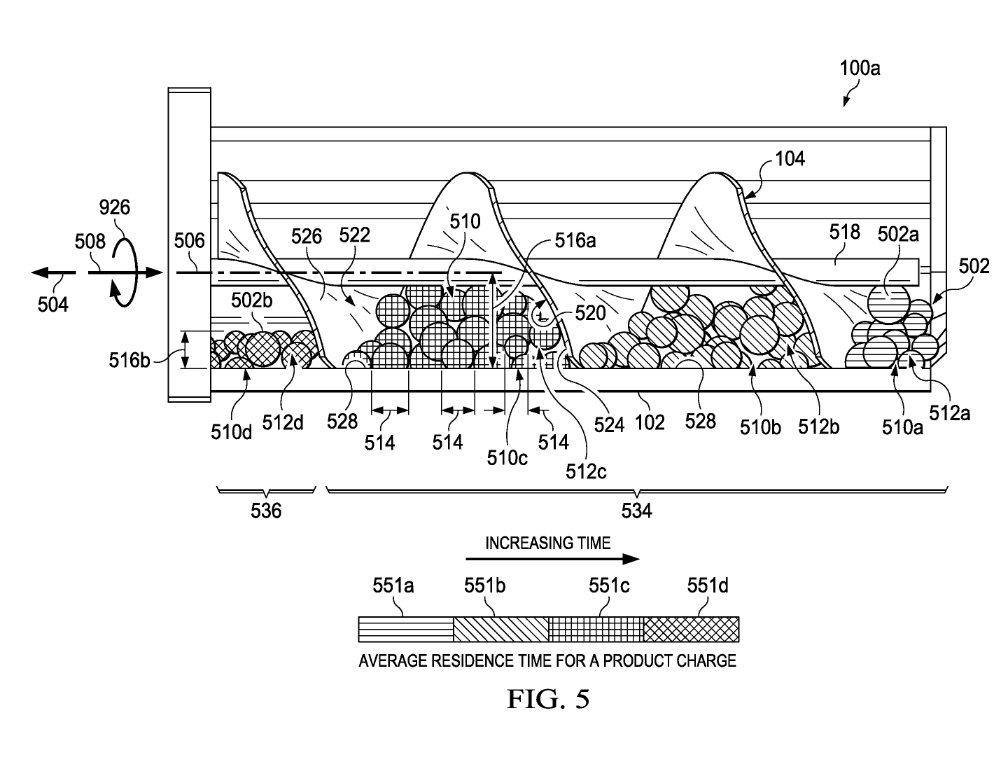

With reference again to FIG. 10A, the confining step 1004 and the rotating step 1008, can be used together to convey a product 502. For example, as illustrated in FIGS. 1 and 5, after product 502 is fed to an auger 104, the product is conveyed in a charge space 510 from a first portion of the product attrition bed 102 (e.g., first or upstream end 144 of the product attrition bed 102) to a second portion of the product attrition bed 102 (e.g., second or downstream end 146 of the product attrition bed 102). As illustrated in FIG. 1, a first end 520 of the charge space 510 (e.g., upstream or trailing end of the charge space) is initially open to an entrance 132 of the auger 104 as the charge space 510 is charged with product. Then, the first end 520 of the charge space 510 closes to confine the product as the charge space 510 moves toward an exit 134 of the auger. Then, as the charge space 510 approaches (e.g. reaches) an exit 134 of the auger, the charge space 510 opens to provide a path for the product charge 512 to flow to the second end 210 of the auger (e.g., exit 134 of the auger).

As illustrated in FIGS. 1-4, as the charge space 510 approaches (e.g., reaches) an exit 134 of the auger, a second end 210 of the auger (e.g., downstream or leading end of the auger) becomes a second end 522 of the charge space 510 (e.g., downstream or leading end of the charge space 510). Accordingly, as the second end 210 of the auger rotates and opens, the second end 522 of the charge space 510 rotates and opens, thereby discharging the product from the charge space 510.

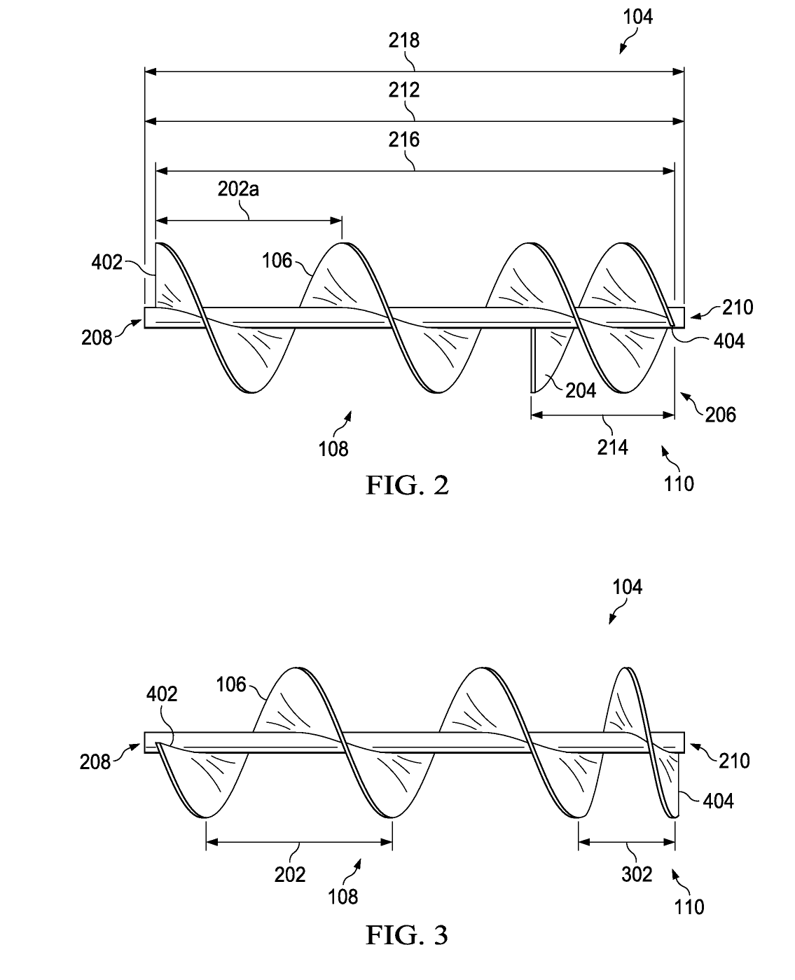

Turning again to FIG. 10A, the discharging step 1010 can comprise restricting the flow of the product charge 512 as it is discharged from an auger 104. For example, as shown in illustrations of FIGS. 2-4, a flow restriction mechanism can be used to restrict the flow of the product from the second end 210 of the auger. For example, the flow restriction mechanism restriction mechanism can be used to decrease the length of the auger from the second end that is open to the exit, for example, 50% by using a double flight, or a smaller pitch that is ½ the pitch of a larger pitch section, or by using a rotary gate that sweeps 180 from the second end of the auger flight.

In some embodiments, the flow restriction mechanism is selected from the group consisting of a rotary gate 406, a downstream portion of the auger (e.g., the second auger section 110) with smaller pitch 302 than an upstream portion of the auger (e.g. the first auger section 108), and a plurality of auger flights 206.

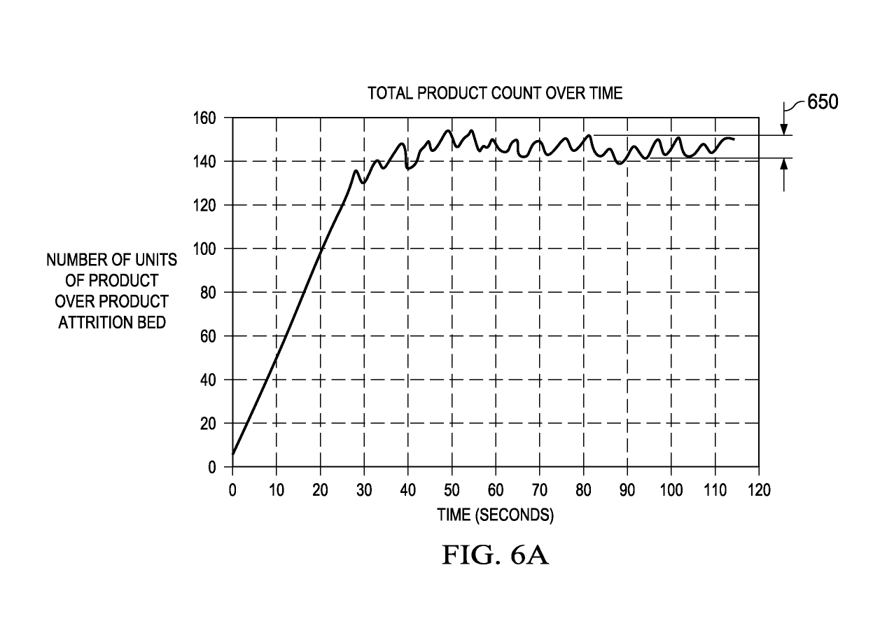

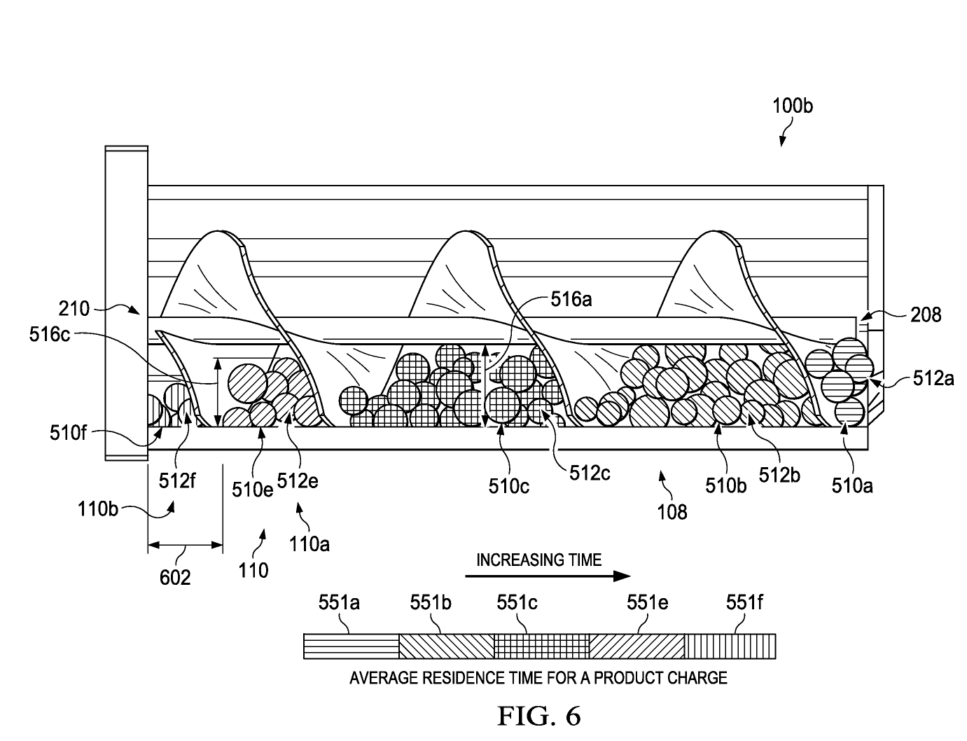

As illustrated in FIGS. 2-4, the flow restriction mechanism is provided in a second auger section 110 that is downstream of a first auger section 108. As shown in FIGS. 5 and 6, the charge space 510 has an upstream bed height 516a before a charge space 510 opens to an exit 134 of the auger (e.g., second end 210 of the auger). The second auger section 110 provides a higher downstream bed height 516c for at least an upstream portion (e.g., the first portion 110a shown in FIGS. 1 and 6) of the product charge 512 as the product charge is discharged from the auger. As used in this context, the term higher downstream bed height 516c is used to denote that the higher downstream bed height 516c in the upstream portion 110a of the product charge is higher than a lower downstream bed height 516b (e.g., lower downstream bed height 516b for an auger 104 without a second auger section 110) that would prevail in the upstream portion 110a of the product charge 512 if the second auger section 110 were to have the same configuration (e.g., same shape, same pitch, same radius, same structure for providing flow restriction) as the first auger section 108.

In some embodiments, the flow restriction mechanism is positioned downstream of a second end 146 (e.g., downstream end) of the product attrition bed 102 to maintain a minimum bed height (e.g., bed height 516c) for substantially an entire length 109 of the product attrition bed. For example, in some embodiments, a portion of an auger 104 comprising the flow restriction mechanism extends downstream of the second end 146 of a product attrition bed 102. Furthermore, in some embodiments the length 216 of an auger flight 106 is greater than the length 109 of a product attrition bed 102.

In some embodiments, the charge space 510 is divided (e.g., partially or completely) in the second auger section 110 by an additional auger flight 204 to form an upstream division (e.g., first portion 110a of the second auger section) and a downstream division (e.g., second portion 110b of the second auger section), thereby limiting the amount of the product charge 512 that loses bed height when the second end 522 (e.g., downstream end or leading end) of the charge space 510 is opened. For example, as illustrated in FIG. 1, the second end 522 of the charge space 510 opens to the exit 134 of the auger 104. However, because the charge space 510 is divided by an additional auger flight 204, only a portion of the product charge 512 can exit the auger when the second end 522 of the charge space 510 is opened.

In some embodiments, for example, as shown in FIG. 3, a length of the charge space 510 in the second auger section 110 (e.g., pitch 302 of the second auger section) is reduced relative to the length of the charge space 510 in the first auger section 108 (e.g., pitch 202 of the first auger section). For example, this can be accomplished by reducing the pitch 302 of the second auger section 110 relative to the first auger section 108. As a result of reducing the length of the charge space 510, the charge space 510 begins to open when the first end 520 of the charge space 510 is positioned closer to the exit 134 of the auger than the first end 520 of the charge space would be positioned if the second auger section 110 had the same configuration as the first auger section 108.

In some embodiments, a rotary gate 406 is provided in the second auger section 110 to constrain the discharge of product 502 from the second auger section 110. For example, the rotary gate 406 can be positioned at the second end 210 of the auger 104 (e.g., downstream or leading end of the auger). Furthermore, the rotary gate 406 can be positioned at the second end 404 of the auger flight 106.

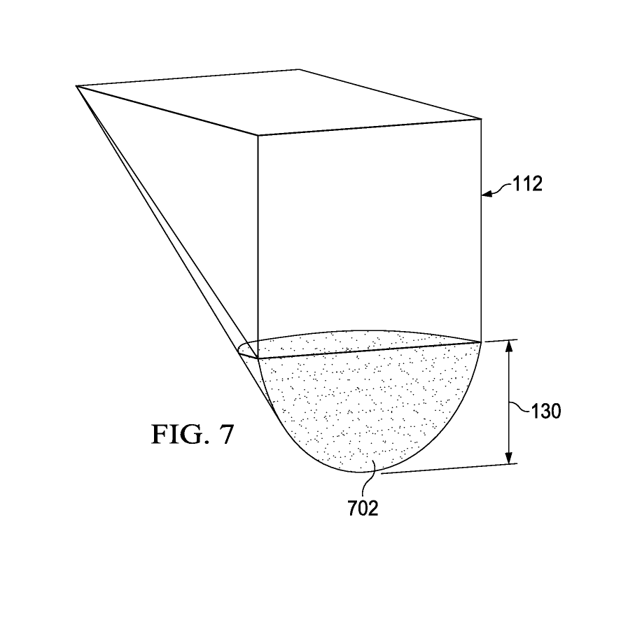

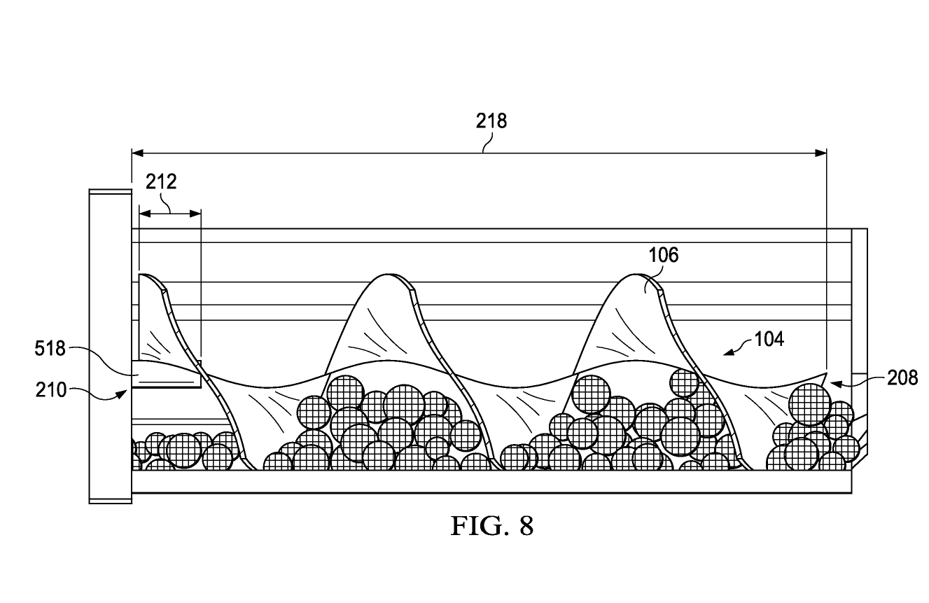

As illustrated in FIG. 8, in some embodiments, the rotation of the auger 104 is driven by applying a force to a drive shaft 518 of the auger. For example, the force can be applied to a drive shaft 518 that extends a shaft length 212 from an end of the auger 208,210 wherein the shaft length 212 is substantially less than an entire length 218 of the auger. In some embodiments, the radius of a drive shaft is minimized to avoid restricting the tumbling motion of product in a charge space 510. In some embodiments, the rotation of the auger 104 is driven by applying a force directly to an auger flight 106 of the auger.

One embodiment of the invention will now be described with reference to FIGS. 1 and 5, which illustrate a product attrition apparatus 100 with improved flow control for a product 502 comprising a plurality of product units 502a,b. The product attrition apparatus 100 comprises a product attrition bed 102 and an auger 104, and the product attrition bed 102 abrades the product 502 while the auger conveys the product in a flow direction 504.

The product attrition bed 102 comprises a first end 144 of the product attrition bed 102, a second end 146 of the product attrition bed 102, a cavity 153 (e.g., trough or cylindrically shaped chamber) that extends from the first end 144 of the product attrition bed 102 to the second end 146 of the product attrition bed 102, and an abrasive 154 that is positioned and oriented to face the auger and that substantially covers the entire surface of the product attrition bed 102.

The auger comprises a rotational axis 506 of the auger oriented in the flow direction 504, an auger flight 106 coiled around the rotational axis 506, a first auger section 108, and a second auger section 110 downstream of the first auger section 108.

As illustrated in FIG. 1, the cavity 153 of the product attrition bed 102 is arcuate and has an axis of curvature that substantially coincides (e.g. is concentric with) the rotational axis 506 of the auger 104. Additionally, a radius of curvature 136 of the product attrition bed 102 is larger than a radius 138 of the auger flight 106, but the difference between the radii 136, 138 is small enough to prevent product 502 from passing through a space 140 between the product attrition bed 102 and the auger flight 106.

As shown in FIG. 1, the auger 104 is configured (e.g., shaped, sized, structured, arranged, positioned, and/or oriented) in relation to the product attrition bed 102 to form a charge space 510 for confining (e.g., completely, substantially, or at least partially confining) a product charge 512 of the product 502. In some embodiments, the auger 104 is positioned above a cavity 153 of the product attrition bed 102, and the auger is positioned to avoid contacting the product attrition bed 102 while rotating (e.g., throughout an entire full revolution). Additionally, as shown in FIG. 1, the auger 104 is positioned at least partially within the cavity 153 of the product attrition bed 102.

In the examples shown in FIGS. 1 and 5, as the auger 104 rotates on the rotational axis 506, the charge space 510 moves in the flow direction 504, thereby moving the product charge 512 in the flow direction 504.

As illustrated in FIG. 1, a charge space 510 can be open on a first end 520 of the charge space 510 (e.g., upstream or trailing end) or a second end 522 of the charge space 510 (e.g., downstream or leading end). When the charge space 510 is not open on one end, the charge space 510 is bounded by the auger 104 and the product attrition bed 102. For example, a first end 520 of the charge space 510 is bounded by a first portion 524 of the auger flight 106; a second end 522 of the charge space 510 is bounded by a second portion 526 of the auger flight 106; and a bottom 528 of the charge space 510 is bounded by the product attrition bed 102. As illustrated, the bottom 528 of the charge space 510 also acts as a first side 530 and second side 532 of the charge space 510 because the bottom and sides are rounded.

As shown in FIG. 1, the auger comprises a first auger section 108 upstream of a second auger section 110. In some embodiments, the first auger section 108 provides for a less obstructed motion of the product charge 512, and the second auger section 110 provides for a relatively more obstructed motion of the product charge 512. In some embodiments, the second auger section 110 comprises a flow restriction mechanism (e.g., reduced pitch 302, a plurality of auger flights 206, or a rotary gate 406) to restrict (e.g., limit) the discharge flow 155 of the product 502, and the first auger section 108 does not comprise a flow restriction mechanism.

As illustrated in FIGS. 1, 2, and 6, in one embodiment, the second auger section 110 comprises a plurality of auger flights 206 (e.g., a double flight). For example, the second auger section 110 can comprise at least one additional auger flight 204 (e.g., to divide a charge space 510). As shown in FIG. 2, a length 214 of the additional auger flight 204 (or a length 214 of the plurality of auger flights 206) extends from approximately an end of the auger (e.g., the second end 210 of the auger). In some embodiments, the additional auger flight 204 (or the plurality of auger flights 206) extends for at least about ¼, ⅓, ½, ¾, or 1 revolution of the additional auger flight 204. For example, as shown in FIG. 2, the additional auger flight 204 extends from a second end 210 of the auger for about 270° of a revolution of the additional auger flight 204, which is about ¾ of a revolution of the additional auger flight 204. In some embodiments, a length 214 of the additional auger flight 204 (or a length 214 of the plurality of auger flights 206) is at least about ¼, ⅓, ½, ¾, or 1 pitch (e.g., of the first auger flight 106 or the additional auger flight 204).

As shown in FIG. 3, in some embodiments, the second auger section 110 comprises a pitch 302 that is smaller than a pitch 202 of the first auger section 108. In one embodiment, the first auger section 108 comprises a minimum pitch 202 of about 4, about 5, or about 6, times an average equivalent spherical diameter 514 of the product 502 (e.g., in the product attrition bed 102, or in the product charge 512). As used herein, the equivalent spherical diameter of a product unit is the diameter of a sphere having the same volume as the product unit. Furthermore, the average equivalent spherical diameter is the average of all the equivalent spherical diameters for the product units in a product.

In one embodiment, the second auger section 110 comprises a maximum pitch 302 of about 4, about 5, or about 6 times an average equivalent spherical diameter 514 of the product. For example, in a first section it can be useful to have a pitch 202 greater than 5 times an average equivalent spherical diameter 514, and in a second section it can be useful to have a pitch 302 less than 2.5 times the average equivalent spherical diameter 514.

In some embodiments a pitch 202 of the first auger section 108 is substantially constant for the entirety of the first auger section 108. Additionally, in some embodiments, a pitch 302 of the second auger section 110 is substantially constant for the entirety of the second auger section 110.

With reference, for example, to FIGS. 1 and 2, in some embodiments, the length 218 of the auger 104 extends (e.g., substantially or completely) the entire length 109 of the product attrition bed 102. In one embodiment, the length 216 of the auger flight 106 is substantially equal to the length 218 of the auger. In one embodiment, a length 216 of the auger flight 106 is substantially equal to the length 109 of the product attrition bed 102 and/or the shaft length 212. In another embodiment, the length 216 of the auger flight 106 can be greater than a length 109 of the product attrition bed 102 and/or the shaft length 212. In one embodiment, the length 216 of the auger flight 106 can be less than a length 109 of the product attrition bed 102 and/or the shaft length 212.

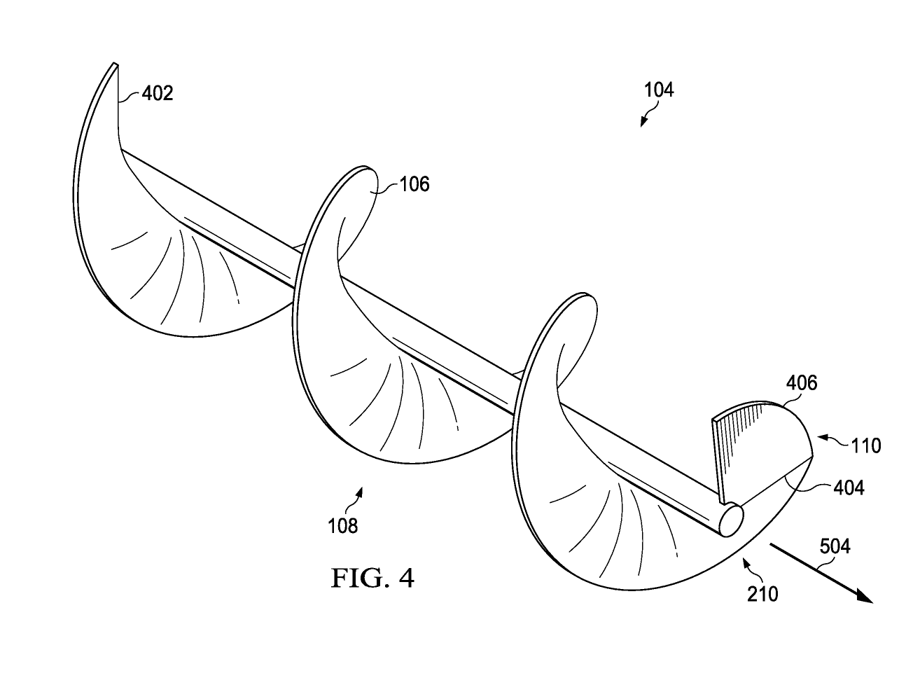

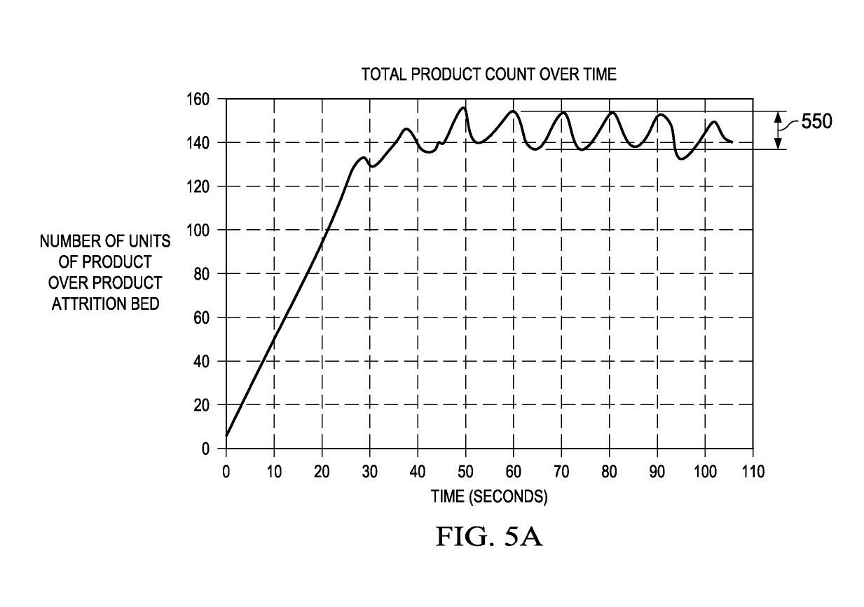

As illustrated, for example, in FIG. 4, in some embodiments, the auger flight 106 comprises a first end 402 of the auger flight 106 (e.g., upstream end, trailing end) and a second end 404 of the auger flight 106 (e.g., downstream end, leading end), and the second auger section 110 comprises a rotary gate 406 that is fixed to the second end 404 of the auger flight 106.

As illustrated in FIG. 6, in some embodiments, as a result of a flow restriction mechanism in the second auger section 110, a minimum bed height 516c, for example, a fraction of the bed height (or average bed height) in the first (e.g., most upstream) closed product charge of the auger, is provided from approximately a first end 208 of the auger to within a selected distance 602 from the second end 210 of the auger. The fraction can be, for example, at least about 75%, 80%, 85%, 90%, 95%, or 100%. The selected distance 602 from the second end 210 of the auger can be equal to or less than the length of the pitch 202 in the first auger section 108. For example, the selected distance 602 can be a maximum of ¼, ⅓, ⅔, or ¾ the length of the pitch 202 of the first auger section 108. As another example, the selected distance 602 can be a maximum of ¼, ⅓, ⅔, ¾ or one length of the pitch 302 of the second auger section 110 if the second auger section has a different pitch than the first auger section as illustrated in FIG. 3. As another example, the selected distance 602 can be a length of a plurality of flights.

With reference to FIGS. 1 and 6, in some embodiments, a minimum bed height 516c is provided from approximately a first end 144 of the product attrition bed 102 to within a selected distance 602 from a second end 146 of the product attrition bed 102. Again, the selected distance 602 can be less than the length of the pitch 202 in the first auger section 108. For example, the selected distance 602 can be a maximum of ¼, ⅓, ⅔, or ¾ the length of the pitch 202 of the first auger section 108. As another example, the selected distance 602 can be a maximum of ¼, ⅓, ⅔, ¾ or one length of the pitch 302 of the second auger section 110 if the second auger section has a different pitch than the first auger section as illustrated in FIG. 3.

In some embodiments, the minimum bed height 516c is a minimum fraction of the average bed height of the product 502 over the length 109 of the product attrition bed 102. For example, in one embodiment, the minimum fraction is at least about 75%, 80%, 85%, 90%, 95%, 100%.

In some embodiments, a minimum bed height is a minimum fraction of the bed height (or average bed height) in the first (e.g., most upstream) closed product charge of the auger. For example, in one embodiment, the minimum fraction is at least 75%, 80%, 85%, 90%, 95%, 100%.

In some embodiments, as illustrated for example in FIG. 5, the auger comprises a drive shaft 518. Although the drive shaft 518 can extend along an entire length of an auger, as shown in FIG. 8, the drive shaft 518 can also be a truncated drive shaft 518 that extends a shaft length 212 from an end of the auger (e.g., the second end 210 of the auger). Additionally, in some embodiments, the auger does not comprise a drive shaft 518.

FIG. 8 illustrates a truncated drive shaft 518 that does not extend along an entire length of an auger. The auger comprises a first end 208 of the auger and a second end 210 of the auger downstream of the first end 208 of the auger. The auger also comprises a first end 402 of the auger flight 106 and a second end 404 of the auger flight downstream of the first end 402 of the auger flight 106 (for reference, see the first end 402 and second end 404 of an auger flight shown in FIGS. 2-4). The drive shaft 518 extends a shaft length 212 from the second end 404 of the auger flight 106, and the shaft length 212 is substantially less than an entire length 218 of the auger and substantially less than an entire length of the auger flight 216 (for reference see an auger flight length 216 shown in FIG. 2). In some embodiments, the shaft length 212 is a fraction of the length 218 of the auger or a fraction of the length 216 of the auger flight. For example, if a plurality of auger flights is used, the shaft length can be the length of the plurality of auger flights. Using a truncated drive shaft 518 or eliminating a drive shaft 518 can be useful, for example, to provide less obstructed mixing, more effective bed height for a product, and more effective volume available to serve as a charge space 510 between an auger 104 and a product attrition bed 102. In some embodiments the drive shaft is fixed to an end of the auger flight, but the drive shaft does not extend along the length of the auger flight.

As illustrated, for example, in FIGS. 1 and 8, the auger 104 does not contact the product attrition bed 102. In some embodiments, the auger 104 (e.g., auger flight 106, or any truncated drive shaft 518) has a sufficiently high mechanical rigidity that the auger can be supported from one end (e.g., first end 208 or second end 210) of the auger and thereby suspended a substantially fixed distance above the product attrition bed 102 (e.g., distance 140 between the auger flight 106 and product attrition bed 102) for the entire length 218 of the auger. This can be useful to prevent the auger from contacting an abrasive 154 on the surface of the product attrition bed 102.

As illustrated in FIG. 1, in some embodiments, the invention also comprises a feed control device for controlling a volumetric feed rate of product 502 to the product attrition apparatus 100. For example, in one embodiment, the invention comprises a container 116, and the container comprises a feed chute 118 for feeding product 502 to the auger 104, a primary gate 120 (e.g., a downstream sliding gate) for controlling (e.g. blocking) a second feed 122 of product from the chute 118 to the auger 104, and a secondary gate 124 (e.g. an upstream sliding gate) for controlling (e.g. blocking) a first feed 126 of product to the chute 118. In the illustration of FIG. 1, the primary gate 120 is downstream of the secondary gate 124.

Although the invention is described herein in terms of a charge space 510, the charge space 510 can be one of a plurality of charge spaces 510. For example, in one embodiment, the product (e.g., a product charge 512) is confined in at least one charge space 510. As another example, in some embodiments, the auger 104 is configured in relation to the product attrition bed 102 to form a plurality of charge spaces 510 for confining a plurality of product charges 512, respectively.

Similarly, although the invention is described in terms of a product charge 512, the product charge 512 can be one of a plurality of product charges 512. For example, in one embodiment, the auger 104 conveys at least one product charge 512. As another example, in some embodiments, the auger 104 is configured in relation to the product attrition bed 102 to convey a plurality of product charges 512.

### COMPARATIVE EXAMPLES

With reference to FIGS. 5 and 6, the advantages provided by the invention can be better understood by comparing a first product attrition apparatus 100a (e.g., first peeler) and a second product attrition apparatus 100b (e.g., second peeler) that are identical except for their augers 104. The first product attrition apparatus 100a comprises a first product attrition bed 102 (e.g., first bed comprising an abrasive 154) and a first auger 104. Meanwhile, the second product attrition apparatus 100b comprises a second product attrition bed 102 (e.g., second bed comprising an abrasive 154) and a second auger 104.

The second product attrition bed 102 is identical to the first product attrition bed 102. Furthermore, the first auger 104 and the second auger 104 have the same auger length 218 and radius, and an initial portion 534 of the first auger is identical to a first auger section 108 of the second auger. Additionally, a terminal portion 536 of the first auger has generally the same configuration (e.g., same pitch, same number of auger flights, same radius, and/or absence of flow restriction mechanism such as rotary gates) as the initial portion 534 of the first auger and the first auger section 108 of the second auger.

However, the second auger section 110 of the second auger 104 advantageously differs from the first auger section 108 of the second auger, the terminal portion 536 of the first auger, and the initial portion 534 of the first auger. For example, the second auger section 110 of the second auger comprises a flow restriction mechanism, which is beneficial because it helps to maintain a minimum bed height 516c of product 502 over the product attrition bed 102. A minimum bed height 516c, in turn, increases the weight of product 502 over the product attrition bed 102 and helps maintain a desirable level of force (e.g., pressure, static head) between an abrasive 154 of the product attrition bed 102 and the product 502.

As illustrated in FIGS. 5 and 6, there is a general correlation between the amount of a product unit 502a,b that is abraded (e.g., peeled) and the residence time of the product unit 502a,b over the product attrition bed 102. For example, a product unit 502a with a shorter residence time will have experienced less attrition (e.g., abrasion) than a product unit 502b with a longer residence time.

FIGS. 5 and 6 illustrate the average residence times 551a,b,c,d,e,f for a plurality of product charges 512a,b,c,d. In FIG. 5, a first product charge 512a (e.g., the most upstream product charge) is in an open charge space 510a because it has just been fed to the auger. It has a first average residence time 551a in the product attrition bed (e.g., over the abrasive) that is the lowest average residence time of the product charges. The second product charge 512b (e.g., the second most upstream product charge) is in the first closed charge space 510b. It has a second average residence time 551b that is the second lowest average residence time. The third product charge 512c (e.g., the third most upstream product charge) is in the second closed charge space 510c. It has a third average residence time 551c that is the third lowest average residence time. The fourth product charge 512d (e.g., the most downstream product charge) is in the second open charge space 510d (e.g., most downstream charge space). It has a fourth average residence time 551d that is the highest average residence time. However, the residence time spend in the fourth product charge is not as effective for abrading the product charge, because the bed height is lower.

FIG. 6 is similar to FIG. 5, except the fourth product charge has been subdivided. For example, a first product charge 512a (e.g., the most upstream product charge) is in a first open charge space 510a because it has just been fed to the auger. It has a first average residence time 551a in the product attrition bed (e.g., over the abrasive) that is the lowest average residence time of the product charges. The second product charge 512b (e.g., the second most upstream product charge) is in the first closed charge space 510b. It has a second average residence time 551b that is the second lowest average residence time. The third product charge 512c (e.g., the third most upstream product charge) is in the second closed charge space 510c. It has a third average residence time 551c that is the third lowest average residence time. The fourth product charge (e.g., the most downstream product charge) is in the second open charge space (e.g., most downstream charge space). However, the fourth product charge has been divided into a first portion 512e (e.g., an upstream portion) and a second portion 512f (e.g., a downstream portion). Similarly, the fourth charge space has been divided into a first portion 510e (e.g., an upstream portion) and a second portion 510f (e.g., a downstream portion). The first portion 512e of the fourth product charge has a fourth average residence time 551e that is the fourth lowest average residence time. The second portion 512f of the fourth product charge has a fifth average residence time 551f that is the highest average residence time. Although the downstream portion 512f of the fourth product charge has a lower bed height, the upstream portion 512e of the fourth product charge has a higher bed height 516c.

FIGS. 5A and 6A illustrate the total number of product units 502 in a product attrition bed over time as calculated by a computer using the discrete elements method to model the product flow. FIG. 5A corresponds to the product attrition apparatus 100a illustrated in FIG. 5. FIG. 6A corresponds to the product attrition apparatus 100b, illustrated in FIG. 6. At startup, the number of product units increases fairly steadily (for example, because a continuous feed of product is fed to the auger at a constant rate). Then, once product begins to be discharged from the product attrition bed (e.g., by the second end of an auger), if the discharge rate exceeds the feed rate, the total number of product units in the product attrition bed starts to decrease. Then, as the discharge rate goes down, or as the feed rate increases, the feed rate exceeds the discharge rate, and the total number of product units in the product attrition bed starts to increase.

The increase and the decrease in the total number of product units over time can be seen in the curves plotted in FIGS. 5A and 6A. For example, the variation in the total number of curves from a local maximum to a subsequent local minimum in the number of product units provides an amplitude 550,650 of a charge-discharge cycle for an auger.

As can be seen, both product attrition beds have an average steady state count of around 143 product units. However, the amplitude for the single pitch, single flight auger illustrated in FIG. 5A is about 20 product units while the amplitude of the single pitch, double flight auger illustrated in FIG. 6A is about 10 product units. In other words, the total number of product units in the product attrition bed of FIG. 5A varies by about 14% of the average steady state number of product units. Meanwhile, the total number of product units in the product attrition bed of FIG. 6A varies by about 7% of the average steady state number of product units.

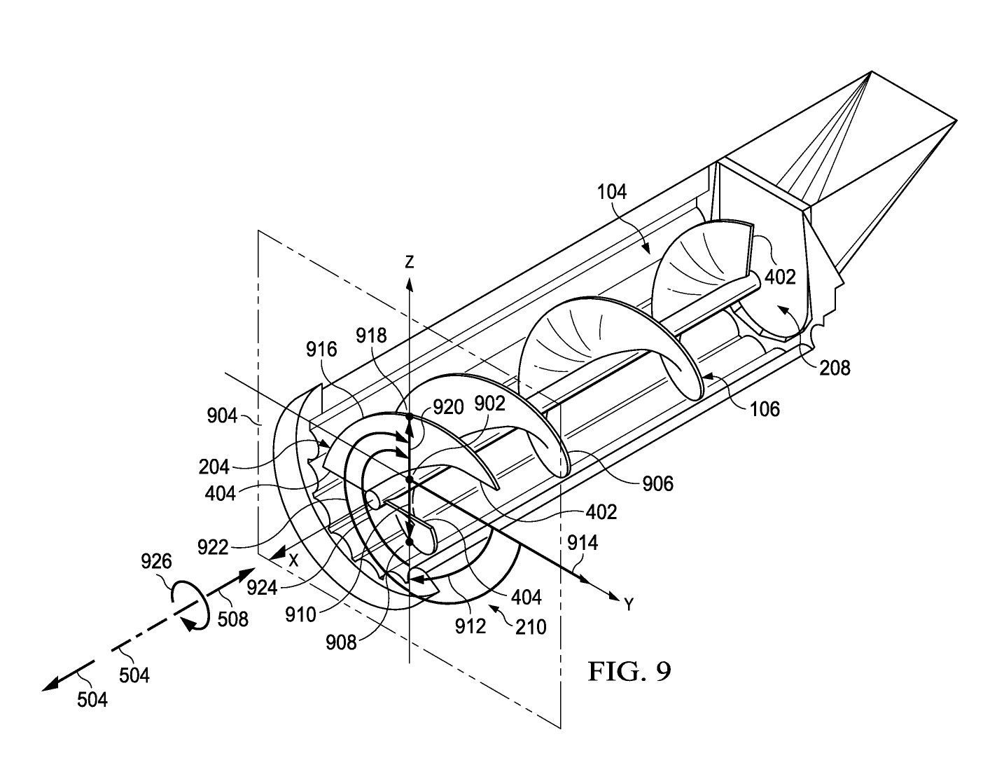

Given an average particle size, the number of particles in a product attrition bed is proportional to the volume of the particles. Furthermore, given a substantially constant bed height until the exit end of the auger, the total number of particles in the auger varies primarily with the bed height at the second end of an auger. Accordingly, the product attrition bed of FIG. 6A has a lower variability in bed height at the second end of the auger. For example, the variability in bed height at the second end of the auger in FIG. 6A is about ½ the variability in the bed height at the second end of the auger in FIG. 5A. Because, some details of the invention are easier to understand with reference to a coordinate system, a Cartesian coordinate system has been provided in FIG. 9. The coordinate system has three mutually perpendicular axes, X, Y, and Z, whose directions are given by X, Y, and Z unit vectors, respectively. The Cartesian coordinate system follows the right-hand rule (e.g., the cross-product of the X unit vector and the Y unit vector points in the direction of the Z unit vector). The X-axis is horizontal and points in the flow direction 504 (e.g., parallel to the rotational axis 506 of the auger and/or axis of curvature of the product attrition bed 102, which is shown in FIG. 1). The Y-axis is horizontal and perpendicular to the flow direction 504. The Z-axis is vertical and perpendicular to the flow direction 504. In the embodiment shown, the auger 104 is shaped to convey the product 502 in the flow direction 504 when the auger rotates with a negative angular velocity 926 (e.g., the rotation of the auger is described by an angular velocity vector 508 that is parallel to but opposite the flow direction 504). However, the auger 104 can also be shaped to convey the product 502 in the flow direction 504 when the auger rotates with a positive angular velocity 926. In some embodiments, the magnitude of the angular velocity of the auger is about 1 to about 30 rpm (rotations per minute).

With reference to FIGS. 1, 2 and 9, one embodiment of the invention comprises a plurality of auger flights 206. As shown, a second auger section 110 comprises an additional auger flight 204 (e.g., a second auger flight with the same rotational axis 506, shape, and pitch 202 as the first flight) extending a length 214 of the additional flight along the rotational axis 506 of the auger from the second end 210 of the auger toward the first end 208 of the auger. Both auger flights 106,204 have substantially constant radii to provide the auger 104 with a substantially constant radius over a length 218 of the auger.

As illustrated in FIG. 9, the additional auger flight 204 is out of phase with the first auger flight 106. For example, given a reference point 902 on the rotational axis 506 of the auger 104 and a normal plane 904 that is perpendicular to the rotational axis 506 at the reference point 902, the outer edge 906 of the first auger flight 106 intersects the normal plane 904 at a first point of intersection 908, and a first vector 910 (e.g., straight line with direction and magnitude) drawn from the reference point 902 to the first point of intersection 908 is at a first angle 912 to a reference vector 914 in the plane (e.g., horizontal vector in the plane) originating at the reference point 902. Additionally, the outer edge 916 of the second auger flight (e.g., additional auger flight 204) intersects the normal plane 904 at a second point of intersection 918, and a second vector 920 drawn from the reference point 902 to the second point of intersection 918 is at a second angle 922 to the reference vector 914 in the plane. Furthermore, the first angle 912 is out of phase with the second angle 922 by a phase shift angle 924 (e.g., 180 degrees, as illustrated in FIG. 9).

In some embodiments, an auger flight 106 begins to open (e.g., discharge a product charge 512 at the second end 210 of the auger) when at least a portion of a second end 404 of the auger flight 106, 204 rotates into a position below horizontal (e.g., a position below parallel to the reference vector 914 in FIG. 9). For example, in some embodiments, when an auger 104 has a negative angular velocity 926 (as shown in FIG. 9), the auger flight 106, 204 begins to open when at least a portion of a second end 404 of the auger flight 106, 204 rotates to an angle less than 0° (with a 0° angle defined by the reference vector 914). In other embodiments, when an auger 104 is a mirror image of the auger 104 shown in FIG. 9 (e.g., mirror image reflected across a vertical plane passing through the rotational axis 506) and when the auger 104 has a positive angular velocity 926 (e.g., opposite of angular velocity 926 shown in FIG. 9), the auger flight 106, 204 begins to open when at least a portion of a second end 404 of the auger flight 106, 204 rotates to an angle greater than 180° (with a 0° angle defined by the reference vector 914).

### Additional Embodiments

The following clauses are offered as further description of the disclosed invention:

1. A product attrition apparatus with improved flow control for a product, wherein the product comprises a plurality of product units, said product attrition apparatus comprising:

a product attrition bed; and

an auger positioned above the product attrition bed;

wherein the product attrition bed abrades the product while the auger conveys the product in a flow direction;

wherein the auger comprises:
a rotational axis of the auger oriented parallel to the flow direction;
an auger flight coiled around the rotational axis
a first auger section; and
a second auger section downstream of the first auger section;

wherein the auger is configured in relation to the product attrition bed to form a charge space for substantially confining a product charge of the product;

wherein, as the auger rotates on the rotational axis, the charge space moves in the flow direction, thereby moving the product charge in the flow direction;

wherein the first auger section comprises a minimum pitch of about 4 times an average equivalent spherical diameter of the product;

wherein the second auger section comprises a flow restriction mechanism to restrict a discharge flow of the product from the auger.

2. The apparatus of clause 1 or 24, wherein the auger flight extends substantially an entire length of the product attrition bed.
3. The apparatus of clause 1 or 24, wherein an entire length of the auger flight is greater than an entire length of the product attrition bed.
4. The apparatus of clause 1 or 24, wherein the flow restriction mechanism is positioned downstream of a downstream end of the product attrition bed to maintain a minimum bed height for an entire length of the product attrition bed.
5. The apparatus of clause 1 or 24, wherein the second auger section comprises at least one additional auger flight.
6. The apparatus of clause 1 or 24, wherein the second auger section comprises a pitch that is smaller than a pitch of the first auger section.
7. The apparatus of clause 1 or 24, wherein the second auger section comprises a maximum pitch of about 6 times an average equivalent spherical diameter of the product.
8. The apparatus of clause 1 or 24, wherein the auger flight comprises a first end of the auger flight and a second end of the auger flight downstream of the first end of the auger flight; wherein the second auger section comprises a rotary gate, and wherein the rotary gate is fixed to the second end of the auger flight.
9. The apparatus of clause 1 or 24, wherein a drive shaft of the auger is fixed to a second end of the auger flight, and wherein the drive shaft of the auger does not extend along a length of the auger flight.
10. The apparatus of clause 1 or 24, wherein the auger comprises a first end of the auger flight and a second end of the auger flight downstream of the first end of the auger flight; wherein the auger comprises a drive shaft, wherein the drive shaft extends along the auger flight for a shaft length from the second end of the auger flight; and wherein the shaft length is substantially less than an entire length of the auger flight.
11. The apparatus of clause 1 or 24, wherein the auger flight does not contact the product attrition bed.
12. The apparatus of clause 1 or 24, further comprising:

a container for providing one control volume of the product to the apparatus per revolution of the auger.

13. The apparatus of clause 1 or 24, further comprising:

a conveyor for feeding a control volume of product to the auger;

wherein the conveyor comprises a plurality of containers;

wherein each container is sized to contain a specific volume;

wherein the specific volume is not greater than the control volume;

wherein dividing the control volume by the specific volume results substantially in an integer;

wherein the conveyor feeds the auger one control volume of product per revolution of the auger by feeding the auger the specific volume from at least one container in the plurality of containers per revolution of the auger.

14. The apparatus of clause 1 or 24, further comprising:

a container,

wherein the container comprises:

a feed chute for feeding product to the auger;

a primary gate for controlling a feed of product from the chute to the auger; and

a secondary control mechanism for controlling a feed of product to the chute;

wherein the primary gate is downstream of the secondary control mechanism.

15. A method for using an auger to control a flow of a product over a product attrition bed, wherein the product comprises a plurality of product units, wherein the auger conveys the product above the product attrition bed in a flow direction while the product attrition bed abrades the product, said method comprising the steps:

feeding the product to the auger to provide a product charge;

substantially confining the product charge in a charge space, wherein a first end of the charge space and a second end of the charge space are bounded by the auger, and wherein a bottom of the charge space is bounded by the product attrition bed;

rotating the auger to move the charge space, and thereby the product charge, in the flow direction; and

discharging the product charge from the auger through a flow restriction mechanism to provide a discharge flow of the product;

wherein a first auger section of the auger is upstream of a second auger section of the auger; and

wherein the second auger section comprises the flow restriction mechanism to restrict the discharge flow of the product.

16. The method of clause 15 or 25, further comprising:

dividing the charge space in the second auger section to form an upstream division and a downstream division, thereby limiting the amount of the product charge that loses bed height when the second end of the charge space is opened;

wherein the second end of the charge space is a downstream end of the charge space.

17. The method of clause 15 or 25, further comprising:

reducing a length of the charge space in the second auger section relative to the length of the charge space in the first auger section.

18. The method of clause 15 or 25, further comprising:

using a rotary gate to restrict the discharge flow of product from the second auger section.

19. The method of clause 15 or 25, further comprising:

driving the rotation of the auger by applying a force to a drive shaft fixed to a an end of an auger flight of the auger, wherein the drive shaft does not extend along a length of the auger flight.

20. The method of clause 15 or 25, further comprising:

driving the rotation of the auger by applying a force to a drive shaft that extends a shaft length from an end of an auger flight of the auger, wherein the shaft length is substantially less than an entire length of the auger flight.

21. The method of clause 15 or 25, wherein the feeding step further comprises:

feeding a control volume of the product to the auger to provide the product charge.

22. The method of clause 15 or 25, wherein the feeding step further comprises:

feeding a control volume of the product to the auger from a conveyor comprising a plurality of containers, wherein each container has a volume not greater than the control volume.

23. The method of clause 15 or 25, wherein the feeding step further comprises:

conveying the product into a chute while a primary gate of the chute is closed and while a secondary control mechanism of the chute is open, wherein the secondary control mechanism is positioned upstream of the primary gate;

measuring a volume of the product accumulated upstream of the primary gate and downstream of the secondary control mechanism;

closing the secondary control mechanism after a specific volume of the product has accumulated upstream of the primary gate and downstream of the secondary control mechanism, wherein the specific volume is not greater than the control volume;

opening the primary gate to discharge the specific volume of the product to the auger to provide at least a portion of the product charge;

closing the primary gate and opening the secondary control mechanism after discharging the specific volume of product to the auger.

24. An apparatus for providing one control volume of a product to an auger per revolution of the auger, wherein the auger extends the length of a product attrition bed for abrading the product as it is conveyed by the auger in a charge space, and wherein the charge space is bounded by the auger and the product attrition bed, said apparatus comprising:

a container; and

a conveyor for feeding product to the container;

wherein the container is sized to hold a specific volume;

wherein dividing the control volume by the specific volume results substantially in an integer; and

wherein the container comprises at least a portion of a feed chute for the auger.

25. A method for controlling a volumetric feed rate of product to an auger positioned over a product attrition bed, said method comprising the steps:

feeding one control volume of the product to the auger per revolution of the auger, wherein the one control volume is accumulated in a hopper before being fed to the auger;

rotating the auger to convey the product in a charge space bounded by the auger and the product attrition bed;

abrading the product by contact with the product attrition bed; and

discharging the control volume from the auger;

wherein the auger extends the length of the product attrition bed.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A product attrition apparatus with improved flow control for a product, wherein the product comprises a plurality of product units, said product attrition apparatus comprising:
a product attrition bed; and
an auger positioned above the product attrition bed;
wherein the product attrition bed abrades the product while the auger conveys the product in a flow direction;
wherein the auger comprises:
a rotational axis of the auger oriented parallel to the flow direction;
an auger flight coiled around the rotational axis
a first auger section; and
a second auger section downstream of the first auger section;
wherein the auger is configured in relation to the product attrition bed to form a charge space for substantially confining a product charge of the product;
wherein, as the auger rotates on the rotational axis, the charge space moves in the flow direction, thereby moving the product charge in the flow direction;
wherein the first auger section comprises a minimum pitch of about 4 times an average equivalent spherical diameter of the product;
wherein the second auger section comprises a flow restriction mechanism to restrict a discharge flow of the product from the auger.

2. The apparatus of claim 1, wherein the auger flight extends substantially an entire length of the product attrition bed.

3. The apparatus of claim 1, wherein an entire length of the auger flight is greater than an entire length of the product attrition bed.

4. The apparatus of claim 1, wherein the flow restriction mechanism is positioned downstream of a downstream end of the product attrition bed to maintain a minimum bed height for an entire length of the product attrition bed.

5. The apparatus of claim 1, wherein the second auger section comprises at least one additional auger flight.

6. The apparatus of claim 1, wherein the second auger section comprises a pitch that is smaller than a pitch of the first auger section.

7. The apparatus of claim 1, wherein the second auger section comprises a maximum pitch of about 6 times an average equivalent spherical diameter of the product.

8. The apparatus of claim 1, wherein the auger flight comprises a first end of the auger flight and a second end of the auger flight downstream of the first end of the auger flight; wherein the second auger section comprises a rotary gate, and wherein the rotary gate is fixed to the second end of the auger flight.

9. The apparatus of claim 1, wherein a drive shaft of the auger is fixed to a second end of the auger flight, and wherein the drive shaft of the auger does not extend along a length of the auger flight.

10. The apparatus of claim 1, wherein the auger comprises a first end of the auger flight and a second end of the auger flight downstream of the first end of the auger flight; wherein the auger comprises a drive shaft; wherein the drive shaft extends along the auger flight for a shaft length from the second end of the auger flight; and wherein the shaft length is substantially less than an entire length of the auger flight.

11. The apparatus of claim 1, wherein the auger flight does not contact the product attrition bed.

12. The apparatus of claim 1, further comprising:
a container for providing one control volume of the product to the apparatus per revolution of the auger.

13. The apparatus of claim 1, further comprising:
a conveyor for feeding a control volume of product to the auger;
wherein the conveyor comprises a plurality of containers;
wherein each container is sized to contain a specific volume;
wherein the specific volume is not greater than the control volume;
wherein dividing the control volume by the specific volume results substantially in an integer;
wherein the conveyor feeds the auger one control volume of product per revolution of the auger by feeding the auger the specific volume from at least one container in the plurality of containers per revolution of the auger.

14. The apparatus of claim 1, further comprising:
a container,
wherein the container comprises:
a feed chute for feeding product to the auger;
a primary gate for controlling a feed of product from the chute to the auger; and
a secondary control mechanism for controlling a feed of product to the chute;
wherein the primary gate is downstream of the secondary control mechanism.

15. A method for using an auger to control a flow of a product over a product attrition bed, wherein the product comprises a plurality of product units, wherein the auger conveys the product above the product attrition bed in a flow direction while the product attrition bed abrades the product, said method comprising the steps:
feeding the product to the auger to provide a product charge;
substantially confining the product charge in a charge space, wherein a first end of the charge space and a second end of the charge space are bounded by the auger, and wherein a bottom of the charge space is bounded by the product attrition bed;
rotating the auger to move the charge space, and thereby the product charge, in the flow direction; and
discharging the product charge from the auger through a flow restriction mechanism to provide a discharge flow of the product;
wherein a first auger section of the auger is upstream of a second auger section of the auger; and
wherein the second auger section comprises the flow restriction mechanism to restrict the discharge flow of the product.

16. The method of claim 15, further comprising:
dividing the charge space in the second auger section to form an upstream division and a downstream division, thereby limiting the amount of the product charge that loses bed height when the second end of the charge space is opened;
wherein the second end of the charge space is a downstream end of the charge space.

17. The method of claim 15, further comprising:
reducing a length of the charge space in the second auger section relative to the length of the charge space in the first auger section.

18. The method of claim 15, further comprising:
using a rotary gate to restrict the discharge flow of product from the second auger section.

19. The method of claim 15, further comprising:
driving the rotation of the auger by applying a force to a drive shaft fixed to a an end of an auger flight of the auger, wherein the drive shaft does not extend along a length of the auger flight.

20. The method of claim 15, further comprising:
driving the rotation of the auger by applying a force to a drive shaft that extends a shaft length from an end of an auger flight of the auger, wherein the shaft length is substantially less than an entire length of the auger flight.

21. The method of claim 15, wherein the feeding step further comprises:
feeding a control volume of the product to the auger to provide the product charge.

22. The method of claim 15, wherein the feeding step further comprises:
feeding a control volume of the product to the auger from a conveyor comprising a plurality of containers, wherein each container has a volume not greater than the control volume.

23. The method of claim 15, wherein the feeding step further comprises:
conveying the product into a chute while a primary gate of the chute is closed and while a secondary control mechanism of the chute is open, wherein the secondary control mechanism is positioned upstream of the primary gate;
measuring a volume of the product accumulated upstream of the primary gate and downstream of the secondary control mechanism;
closing the secondary control mechanism after a specific volume of the product has accumulated upstream of the primary gate and downstream of the secondary control mechanism, wherein the specific volume is not greater than the control volume;
opening the primary gate to discharge the specific volume of the product to the auger to provide at least a portion of the product charge;
closing the primary gate and opening the secondary control mechanism after discharging the specific volume of product to the auger.

24. An apparatus for providing one control volume of a product to an auger per revolution of the auger, wherein the auger extends the length of a product attrition bed for abrading the product as it is conveyed by the auger in a charge space, and wherein the charge space is bounded by the auger and the product attrition bed, said apparatus comprising:
a container; and
a conveyor for feeding product to the container;
wherein the container is sized to hold a specific volume;
wherein dividing the control volume by the specific volume results substantially in an integer; and
wherein the container comprises at least a portion of a feed chute for the auger.

25. A method for controlling a volumetric feed rate of product to an auger positioned over a product attrition bed, said method comprising the steps:
feeding one control volume of the product to the auger per revolution of the auger, wherein the one control volume is accumulated in a hopper before being fed to the auger;
rotating the auger to convey the product in a charge space bounded by the auger and the product attrition bed;
abrading the product by contact with the product attrition bed; and
discharging the control volume from the auger;
wherein the auger extends the length of the product attrition bed.
